(19) United States
(12) Patent Application Publication
(10) Pub. No.: US 2019/0188042 A1
(43) Pub. Date: Jun. 20, 2019

(54) System and Method of Image Analyses

(71) Applicant: GORILLA TECHNOLOGY INC., Taipei City (TW)

(72) Inventors: SIH-PING KOH, Taipei City (TW); NUO PAI HSU, Taipei City (TW)

(21) Appl. No.: 16/167,558

(22) Filed: Oct. 23, 2018

(30) Foreign Application Priority Data
Dec. 18, 2017 (TW) 106144368

(51) Int. Cl. G06F 9/50; G06K 9/00; H04N 7/18

(52) U.S. Cl. CPC G06F 9/5038; G06K 9/00771; H04N 7/181; G06F 9/505; G06K 9/00711

(57) ABSTRACT

An image analysis system can schedule a plurality of different inputted video streams for performing real-time image analysis thereof in different time segments, respectively, so as to maximize the usage of the limited resources of an image analysis module of the image analysis system, wherein the image analysis module is unable to perform real-time image analysis on all the plurality of video streams at the same time due to the limited resources of the image analysis module.

### CROSS-REFERENCE TO RELATED APPLICATION

This application claims the Priority of Taiwan application No. 106144368 filed Dec. 18, 2017, the disclosure of which is incorporated herein in its entirety by reference.

### BACKGROUND OF THE INVENTION

### 1. Field of the Invention

The present invention relates to a system and method for image analysis, and more particularly, to a system and method for real-time image analysis.

### 2. Description of the Prior Art

Conventional video recording devices designed for specific functions have limited hardware resources for image analysis that requires a large amount of computing power, and therefore can only analyze a small amount of image content as their main focus are still on video image storage and video image playback. Furthermore, conventional video recording devices are not capable of scheduling hardware resources to analyze different inputted video streams at different time segments so as to achieve better utilization of the hardware resources for image analysis. Therefore, there is a need to provide an image analysis system to resolve the above issues.

### SUMMARY OF THE INVENTION

One object of the present invention is to provide an analysis system capable of scheduling a plurality of different inputted video streams at a plurality of different time segments according to the time nature of different inputted video streams to perform real-time image analysis thereof, respectively, so as to fully use the limited resources of the image analysis system.

One embodiment of the present invention provides a system for image analysis, the system comprising: an image receiving module for inputting a plurality of video streams; a video recording module for storing video streams; an image analysis module for analyzing video streams; and a scheduling module for scheduling the plurality of inputted video streams according to user-selected time segments and the resources of the image analysis module, wherein each of the plurality of inputted video streams is either scheduled at a corresponding user-selected time segment for performing online real-time image analysis of the inputted video stream or recorded for performing offline image analysis of the inputted video stream so as to enable the image analysis module to perform online real-time image analysis for different inputted video streams at different time segments, wherein the image analysis module has limited resources and is not capable of performing online real-time image analysis for all of the plurality of inputted video streams at the same time. Please note that offline image analysis means that the image analysis work is carried out in non-real time manner based on a recorded video stream.

In one embodiment, the resources of the image analysis module include at least one CPU.

In one embodiment, the resources of the image analysis module further include at least one NPU.

In one embodiment, the resources of the image analysis module further include at least one image processing hardware accelerator.

In one embodiment, after scheduling said different inputted video streams at said different time segments for performing real-time image analysis thereof, the scheduling module uses remaining resources and time segments to schedule at least one video stream for performing offline image analysis thereof.

In one embodiment, the image analysis module includes an algorithm for analyzing video streams, wherein the tasks of the algorithm are divided into a plurality of different levels such that the image analysis module only performs a lower-level task of the algorithm for at least one video stream in real time and stores the analysis results of the lower-level task of the algorithm, after which the image analysis module then performs a higher-level task of the algorithm for said at least one video stream off line at corresponding scheduled time segments.

In one embodiment, a first video stream and a second video stream are respectively scheduled at a first time segment and a second time segment for performing real-time image analysis thereof, wherein a third video stream is recorded and scheduled at a third time segment for performing offline image analysis thereof.

In one embodiment, a first part of the analysis work of the third video stream is scheduled at said first time segment for performing real-time image analysis thereof, and a second part of the analysis work of the third video stream is scheduled at a third time segment for performing offline image analysis thereof.

In one embodiment, a lowest-level task of the algorithm is the motion detection of an object, a middle-level task of the algorithm is the identification of the object, and a highest-level task of the algorithm is the behavior analysis of the object.

One embodiment of the present invention provides a method for image analysis, the method comprising: scheduling at least one first video stream of a plurality of different inputted video streams at a first time segment for performing online real-time image analysis according to a first user-selected time segment; and scheduling at least one second video stream of the plurality of different inputted video streams for performing online real-time image analysis according to a second user-selected time segment, wherein image-analysis resources is not enough for performing online real-time image analysis for all of the plurality of different inputted video streams at the same time.

In one embodiment, remaining resources and time segments are used for scheduling other video streams for performing offline image analysis thereof after scheduling said at least one first video stream and said at least one second video stream for performing real-time image analysis thereof.

In one embodiment, a first video stream and a second video stream are respectively scheduled at a first time segment and a second time segment for performing real-time image analysis thereof, wherein a third video stream is recorded and scheduled at a third time segment for performing offline image analysis thereof.

In one embodiment, a first part of the analysis work of the third video stream is scheduled at said first time segment for performing real-time image analysis thereof, and a second part of the analysis work of the third video stream is scheduled at a third time segment for performing offline image analysis thereof.

In one embodiment, an algorithm is used for analyzing video streams, wherein the tasks of the algorithm are divided into a plurality of different levels such that the image analysis module only performs a lower-level task of the algorithm for at least one video stream in real time and stores the analysis results of the lower-level task of the algorithm, and then the image analysis module performs a higher-level task of the algorithm for said at least one video stream off line at corresponding scheduled time segments.

In one embodiment, a lower-level task of the algorithm is the motion detection of an object, a middle-level task of the algorithm is the identification of the object, and an upper-level task of the algorithm is the behavior analysis of the object.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 illustrates a schematic diagram of an image analysis system according to one embodiment of the present invention;

FIG. 2 illustrates a flowchart of an image analysis method according to one embodiment of the present invention;

FIG. 3 illustrates a flowchart of an image analysis method according to another embodiment of the present invention; and

FIG. 4A-4B each illustrates a schematic diagram of scheduling of image analysis work of video streams according to one embodiment of the present invention.

### DESCRIPTION OF THE PREFERRED EMBODIMENT

The foregoing as well as other technical contents, features, and effects of the present invention will be clearly apparent from the following detailed description with reference to the preferred embodiments of the drawings. However, it should be noted that the following embodiments are not intended to limit the present invention.

The image analysis system of the present invention can schedule a plurality of different inputted video streams for performing real-time image analysis thereof in different time segments, respectively, so as to maximize the usage of the limited resources of the image analysis module of the image analysis system, wherein the image analysis module is unable to perform real-time image analysis on all the plurality of video streams at the same time due to the limited resources of the image analysis module.

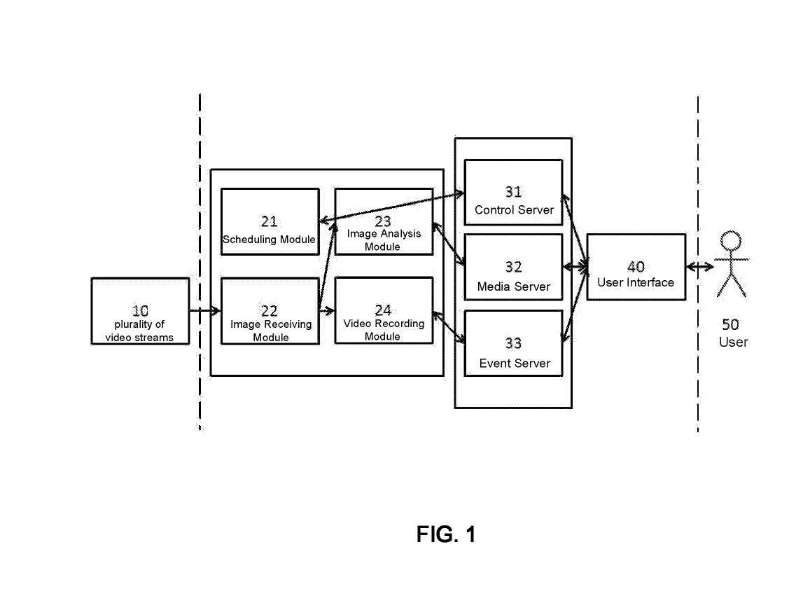

Please refer to FIG. 1. The image analysis system comprises: an image receiving module 22 for inputting a plurality of video streams 10; a video recording module 24 for storing video streams; an image analysis module 23 for analyzing the video streams; and a scheduling module 21 for scheduling the plurality of inputted video streams according to user-selected time segments and the resources of the image analysis module 23, wherein each of the plurality of inputted video streams 10 is either scheduled at a corresponding user-selected time segment for performing online real-time image analysis of the inputted video stream or recorded for performing offline image analysis of the inputted video stream so as to enable the image analysis module 23 to perform online real-time image analysis for different inputted video streams at different time segments, wherein the image analysis module 23 has limited resources and is not capable of performing online real-time image analysis for all of the plurality of inputted video streams 10 at the same time. Real-time image analysis is suitable for tasks that require immediate analysis results for responding to some events or prompt warnings.

Please refer to FIG. 1, in one embodiment, the control server 31 is configured to forward user instructions 50 and system information through the user interface 40.

Please refer to FIG. 1, in one embodiment, a media server 32 is used for streaming real-time videos and data of analysis results.

Please refer to FIG. 1, in one embodiment, the event server 33 is configured to store, check, and forward an analysis event.

In one embodiment, the user interface 40 directly communicates with the said modules 21, 22, 23, 24 without using the control server 31, the media server 32 and the event server 33.

Each of the plurality of video streams 10 can come from various locations, for example, the video streams 10 can come from a surveillance device at a gate of a home or company, or a surveillance device inside a home or a company, or a monitoring device for monitoring traffic flow during peak hours, or video streams uploads from network, and etc. If online real-time image analysis for all of the inputted video streams are performed at the same time, the image analysis module 23 needs a great deal of resources, such as many processors, to perform online real-time image analysis for all of the inputted video streams at the same time, which will make the image analysis system too large and costly. However, online real-time image analysis for video streams from different locations can be performed at different time segments according to time nature of each video stream so as to avoid the above-mentioned problem causing the image analysis system too large and costly, for example, online real-time image analysis work for the video stream coming from the monitoring device for monitoring traffic flow can be carried out during the peak hours only.

In one embodiment, the image analysis system of the present invention can estimate the computing resources for executing each analysis task. Prior to this, the image analysis system can evaluate the maximum available resources including computing resources for image analysis according to the hardware resources of the image analysis system. The scheduling module 21 arranges each of the inputted video streams 10 at a time segment for performing online image analysis thereof according to the user-selected time segment and the remaining available resources of the image analysis module 23. However, for a particular video stream, if there is not enough resources of the image analysis module 23 to perform online image analysis at a user-selected segment, that particular video stream will be recorded for performing offline image analysis later on so as to enable the image analysis module to perform online real-time image analysis for different inputted video streams at different time segments while other video streams that do not require immediate analysis result can be recorded for performing offline image analysis in some unused time segments or those time segments that still have some remaining available resources in the image analysis module 23. The image analysis system can first set analysis conditions and priorities for those video streams that are not arranged for real-time image analysis so that offline image analysis of each of those video streams can be performed in sequence. Uploaded video clips can also be analyzed based on specified analysis conditions and priorities.

In one embodiment, the image analysis system of the present invention can intelligently automatically schedule based on algorithm characteristics, hardware characteristics, and video streams that require real-time image analysis during a specific time period. The remaining resources of the image analysis system can then be used for performing offline image analysis on those video streams that do not require real-time image analysis to achieve the highest usage of the resources of the image analysis system. The tasks of the algorithm can be divided into several hierarchical levels, for example, a low-level task is motion detection of a moving object, and a middle-level task is the object recognition, such as human, car or others, and an upper-level task is the behavior analysis, such as fighting or gathering of people, or illegal parking, changing lanes of cars, etc. Based on such characteristics, intelligent scheduling of present invention can schedule analysis work of multiple video streams sharing a common low-level task at a same time segment; more flexibly, the results of the lower-level tasks of the algorithm can be stored, and then the higher-level task of the algorithm can be performed until the resources of the image analysis module 23 free up. In the scheduling, the resources of the image analysis module 23 used by the algorithm will be considered to make the most appropriate allocation. In one embodiment, the resources of the image analysis module 23 include at least one GPU and at least one CPU. The object classification mainly requiring the GPU resources and the license plate detection and recognition mainly requiring the CPU resources can be scheduled at a same time segment for achieving the highest utilization efficiency of CPU and GPU. In one embodiment, the resources of the image analysis module 23 include at least one CPU. In one embodiment, the resources of the image analysis module 23 include at least one CPU and at least one image processing hardware accelerator. In one embodiment, the resources of the image analysis module 23 include at least one CPU, at least one GPU, and at least one image processing hardware accelerator.

In one embodiment, to support a variety of different situations, the various video streams described above may be scheduled at various time segments within 24 hours of the day to perform online real-time image analysis. The various video streams described above can also be scheduled at various time segments of a week to perform online real-time image analysis. Likewise, the various video streams described above can be scheduled at various time segments of a month to perform online real-time image analysis.

In the present invention, any of the image receiving module 22, the video recording module 24, the scheduling module 21 and the image analysis module 23 of the image analysis system can be made of hardware or combination of software and hardware.

In one embodiment, the scheduling module 21 will schedule different time segments to perform real-time image analysis for different inputted video streams first, and then unused resources and time segments can be scheduled to perform offline image analysis for other video streams.

In one embodiment, the image analysis module 23 includes an algorithm for analyzing video streams, wherein the tasks of the algorithm are divided into a plurality of different levels such that the image analysis module 23 only performs a lower-level task of the algorithm for a video stream in real time and stores the analysis results of the lower-level task of the algorithm, and then the image analysis module 23 performs a higher-level task of the algorithm at corresponding scheduled time segments off line.

In one embodiment, a lowest-level task of the algorithm is the motion detection of an object, a middle-level task of the algorithm is the identification of the object, and a highest-level task of the algorithm is the behavior analysis of the object.

The image analysis method of the present invention is capable of scheduling a plurality of different inputted video streams at a plurality of different time segments for performing real-time image analysis according to the time nature of each of the video streams in order to fully use the limited resources of the image analysis module of the image analysis system.

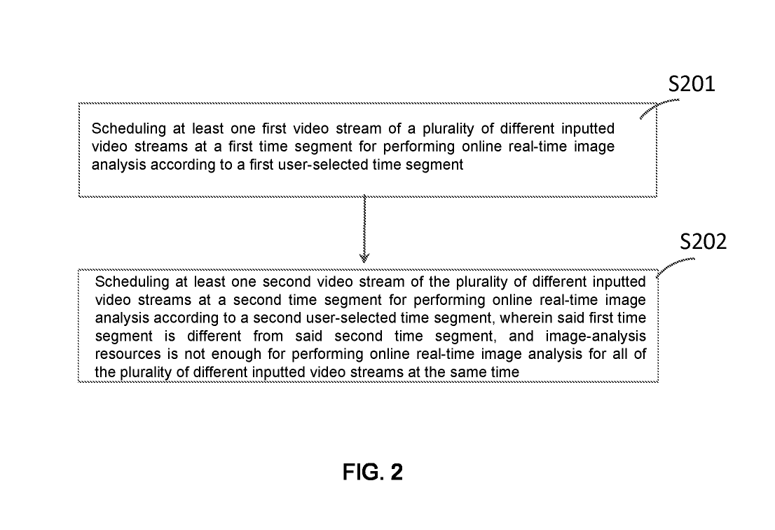

As shown in FIG. 2 which illustrate the flow of the image analysis method, in step 201, scheduling at least one first video stream of a plurality of different inputted video streams at a first time segment for performing online real-time image analysis according to a first user-selected time segment; and in step 202, scheduling at least one second video stream of the plurality of different inputted video streams at a second time segment for performing online real-time image analysis according to a second user-selected time segment, wherein said first time segment is different from said second time segment, and image-analysis resources is not enough for performing online real-time image analysis for all of the plurality of different inputted video streams at the same time.

In one embodiment, if real-time image analysis cannot be performed for a video stream due to the limited resources of image analysis module, the video stream will be stored for offline image analysis later on.

In one embodiment, the image analysis method includes an algorithm for analyzing video streams, wherein the tasks of the algorithm are divided into a plurality of different levels, wherein lower-level task of the algorithm will be carried out in real time and the analysis results of the lower-level task of the algorithm will be stored, and then a higher-level task of the algorithm will be carried out off line later on.

In one embodiment, a lowest-level task of the algorithm is the motion detection of an object, a middle-level task of the algorithm is the identification of the object, and a highest-level task of the algorithm is the behavior analysis of the object.

In one embodiment, the image analysis method can schedule analysis work of multiple video streams sharing a common low-level task at a same time segment; more flexibly, the results of the lower-level tasks of the algorithm can be stored, and then the higher-level task of the algorithm can be performed until the resources of the image analysis module free up.

The image analysis method of the present invention is capable of scheduling a plurality of different inputted video streams at different time segments for perform real-time image analysis, respectively, according to the time nature of said different inputted video streams so as to fully use the limited resources of the image analysis system.

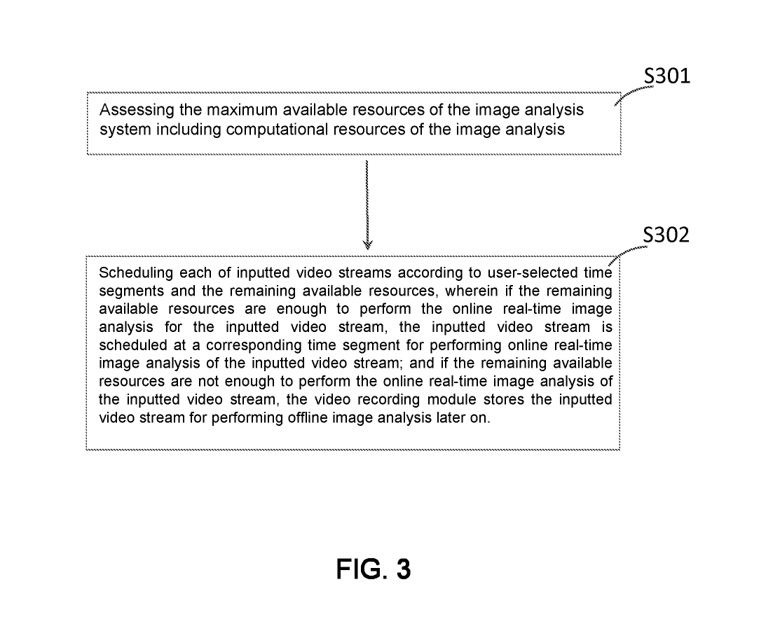

FIG. 3 shows a flow chart of the image analysis method in another embodiment of the present invention. As shown in FIG. 3, in step 301, assesses the maximum available resources of the image analysis system including computational resources of the image analysis; and in step 302, scheduling each of inputted video streams according to user-selected time segments and the remaining available resources, wherein if the remaining available resources are enough to perform the online real-time image analysis for the inputted video stream, the inputted video stream is scheduled at a corresponding time segment for performing online real-time image analysis of the inputted video stream; and if the remaining available resources are not enough to perform the online real-time image analysis of the inputted video stream, the video recording module stores the inputted video stream for performing offline image analysis later on.

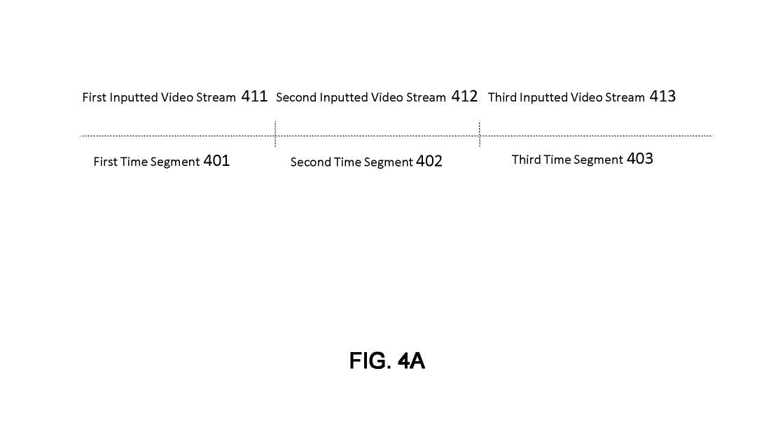

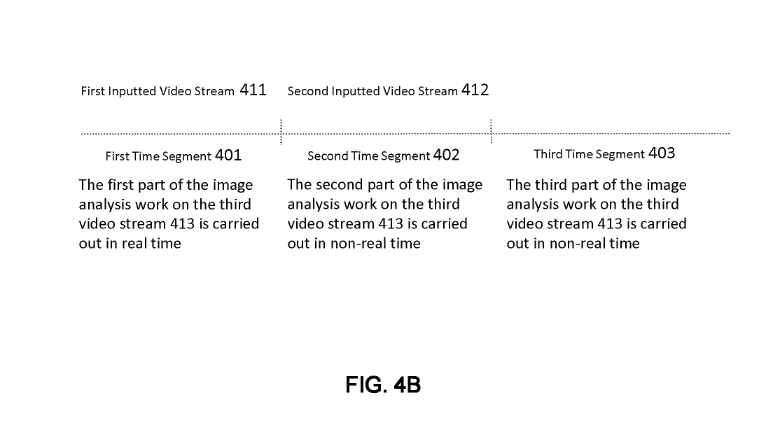

Referring to FIG. 4A, in one embodiment of the above-described image analysis system and image analysis method of the present invention, real-time image analysis can be performed on the first video stream, the second video stream, and the third video stream during the first time segment 401, the second time segment 402, and the third time segment 403, respectively.

Referring to FIG. 4B, in one embodiment of the above-described image analysis system and image analysis method of the present invention, real-time image analysis can be performed on the first video stream and the second video stream during the first time segment 401 and the second time segment 402, respectively. However, the image-analysis resources are not enough for performing real-time image analysis for both of the first video stream and the third video stream in the first time segment 401. Therefore, the first part of the image analysis work on the third video stream 413 can be completed during the first time segment 401 in real time, the second part of the image analysis work on the third video stream 413 can be completed during the second time segment 402 in non-real time, and the third part of the image analysis work on the third video stream 413 can be completed during the third time segment 403 in non-real time.

As described above, the image analysis method and system of the present invention is capable of scheduling a plurality of different inputted video streams at a plurality of different time segments according to the time nature of different inputted video streams to perform real-time image analysis thereof, respectively, so as to fully use the limited resources of the image analysis system.

The above-mentioned descriptions represent merely the exemplary embodiment of the present invention, without any intention to limit the scope of the present invention thereto. Various equivalent changes, alternations or modifications based on the claims of present invention are all consequently viewed as being embraced by the scope of the present invention.

What is claimed is:

1. An image analysis system, comprising:
an image receiving module for inputting a plurality of video streams;
a video recording module for storing video streams;
an image analysis module for analyzing video streams; and
a scheduling module for scheduling the plurality of inputted video streams according to user-selected time segments and the resources of the image analysis module, wherein each of the plurality of inputted video streams is either scheduled at a corresponding user-selected time segment for performing online real-time image analysis of the inputted video stream or recorded for performing offline image analysis of the inputted video stream so as to enable the image analysis module to perform online real-time image analysis for different inputted video streams at different time segments, wherein the image analysis module has limited resources and is not capable of performing online real-time image analysis for all of the plurality of inputted video streams at the same time.

2. The system according to claim 1, wherein the resources of the image analysis module include at least one CPU.

3. The system according to claim 2, wherein the resources of the image analysis module further include at least one NPU.

4. The system according to claim 2, wherein the resources of the image analysis module further include at least one image processing hardware accelerator.

5. The system according to claim 1, wherein the scheduling module uses remaining resources and time segments to schedule at least one video stream for performing offline image analysis thereof, after scheduling said different inputted video streams at said different time segments for performing real-time image analysis thereof.

6. The system according to claim 1, wherein a first video stream and a second video stream are respectively scheduled at a first time segment and a second time segment for performing real-time image analysis thereof, wherein a third video stream is recorded and scheduled at a third time segment for performing offline image analysis thereof.

7. The system according to claim 6, wherein a first part of the analysis work of the third video stream is scheduled at said first time segment for performing real-time image analysis thereof, and a second part of the analysis work of the third video stream is scheduled at a third time segment for performing offline image analysis thereof.

8. The system according to claim 1, wherein the image analysis module includes an algorithm for analyzing video streams, wherein the tasks of the algorithm are divided into a plurality of different levels such that the image analysis module only performs a lower-level task of the algorithm for a video stream in real time and stores the analysis results of the lower-level task of the algorithm, and then the image analysis module performs a higher-level task of the algorithm for said video stream off line at a corresponding scheduled time segment.

9. The system according to claim 1, wherein the image analysis module includes an algorithm for analyzing video streams, wherein the tasks of the algorithm are divided into a plurality of different levels, wherein a lowest-level task of the algorithm is the motion detection of an object, a middle-level task of the algorithm is the identification of the object, and a highest-level task of the algorithm is the behavior analysis of the object.

10. A method for performing image analysis, comprising:
scheduling at least one first video stream of a plurality of different inputted video streams at a first time segment for performing online real-time image analysis according to a first user-selected time segment; and
scheduling at least one second video stream of the plurality of different inputted video streams at a second time segment for performing online real-time image analysis according to a second user-selected time segment, wherein said first time segment is different from said second time segment, and resources is not enough for performing online real-time image analysis for all of the plurality of different inputted video streams at the same time.

11. The method according to claim 10, wherein remaining resources and time segments are used for scheduling at least one video third stream for performing offline image analysis thereof, after scheduling said at least one first video stream and said at least one second video stream for performing real-time image analysis thereof.

12. The method according to claim 10, wherein a first video stream and a second video stream are respectively scheduled at a first time segment and a second time segment for performing real-time image analysis thereof, wherein a third video stream is recorded and scheduled at a third time segment for performing offline image analysis thereof.

13. The method according to claim 12, wherein a first part of the analysis work of the third video stream is scheduled at said first time segment for performing real-time image analysis thereof, and a second part of the analysis work of the third video stream is scheduled at a third time segment for performing offline image analysis thereof.

14. The method according to claim 10, wherein an algorithm is used for analyzing video streams, wherein the tasks of the algorithm are divided into a plurality of different levels such that the image analysis module only performs a lower-level task of the algorithm for a video stream of said other video streams in real time and stores the analysis results of the lower-level task of the algorithm, and then the image analysis module performs a higher-level task of the algorithm for said video stream off line at a corresponding scheduled time segment.

15. The method according to claim 10, wherein an algorithm is used for analyzing video streams, wherein the tasks of the algorithm are divided into a plurality of different levels, wherein a lower-level task of the algorithm is the motion detection of an object, a middle-level task of the algorithm is the identification of the object, and an upper-level task of the algorithm is the behavior analysis of the object.
